(19) United States
(12) Patent Application Publication
(10) Pub. No.: US 2012/0025038 A1
(43) Pub. Date: Feb. 2, 2012

(54) Mounting Bracket

(75) Inventors: Michael Charles Seelman, Flanders, NJ (US); Peter J. Osowski, West Milford, NJ (US)

(73) Assignee: VANGUARD ENERGY PARTNERS, LLC, Branchburg, NJ (US)

(21) Appl. No.: 12/845,991

(22) Filed: Jul. 29, 2010

(51) Int. Cl. F16M 11/08; F16M 11/04; F16M 13/00

(52) U.S. Cl. 248/125.7; 248/309.1; 248/274.1; 248/121

(57) ABSTRACT

A mounting bracket is provided for attaching a support beam to a vertical support post at a pre-determined angle. The mounting bracket has a cavity for receiving the vertical support post, the cavity being attached to a side of a support plate at the pre-determined angle. The support plate is attached to the support beam, such that the support beam is supported from the ground at the desired angle. The mounting bracket is used in installations requiring a consistent angular relationship between the vertical support post and the support beam, such as solar panel arrays.

### FIELD OF INVENTION

The invention is an improved mounting bracket for use in structural support applications. The invention is particularly suited for use with ground-mounted solar panel installations and other outdoor installations.

### BACKGROUND

Joining two support beams at angles other than perpendicular presents a number of challenges. A common method involves placing the support beams at the desired angle and attaching the beams with two or more rivets, bolts, nails, screws or other attachment means. This method is suitable for a small number of assemblies, but as the number of assemblies increase, this method becomes less and less efficient. Ensuring that the support beams in each assembly are joined at the correct angle requires measuring the angle each time the beams are joined.

Certain assemblies may use pre-drilled holes in the beams for the beams to be at the correct angle. Each such assembly requires placing the beams and their respective holes into alignment and then inserting the attachment means. Where the assemblies do not use pre-drilled holes, the beams must be placed into the correct position and at the correct angle for each assembly. In these scenarios, the positioning of the assembly takes time and effort in order to achieve the desired angle of the assembly.

Often the angle of the assembly is desired to be consistent over several separate assemblies. An example of particular importance arises in the installation of ground mounted solar panel arrays.

Solar panel arrays in outdoor installations are often comprised of several photoelectric panels supported by channels as is known in the art. The channels provide structural support for the photoelectric panels and also provide spaces for the electric wires running from the panels to external circuitry.

For ground mount solar panel arrays, the channels are supported by a series of support posts inserted into the ground, roughly perpendicular to the surface of the ground. The solar energy panels are preferably oriented to face the path of the sun at the location, to maximize the exposure of the solar panels to the rays of the sun. At any given latitude, there is a desired angle of the orientation of a solar panel, as is known to those skilled in the art. The channel supporting the solar panels is usually parallel to the plane of the solar panels, and accordingly is oriented at a particular angle with respect to the support post.

While solar panel installations appear to require only exposure to sunlight, in certain climates, solar panel installations cannot rely on optimum weather conditions to exist for every day of operation. Accordingly, the solar panel installation must be able to handle the worst weather conditions in a particular climate. The nature of photoelectric panels requires that the photoelectric panels have a wide surface area, and a solar panel array of photoelectric panels covers wide areas. Accordingly, solar panel arrays are especially susceptible to damage from high winds. It is important that ground-mount installations of solar panel arrays be securely anchored to the ground. Failure to provide sufficient anchoring can result in damage to the solar panel arrays, as well as damage to surrounding property in the event that one or more photoelectric panels becomes dislodged from its ground support. Accordingly, solar panel support structures including the joining of the posts and channels must be sturdy and resistant to the effects of adverse weather conditions.

In determining whether to install solar panel arrays, the cost of installation on a per panel basis is weighed against the expected savings in conventional energy sources. Most businesses looking to install solar panel arrays expect a return on the investment after several years. Current efficiency levels of solar energy panels make the cost of installation and maintenance significant factors in implementing solar energy as an alternative to traditional energy sources. Reducing the per panel installation cost can have the effect of increasing the number of installations. For ground-mounted solar panel installations, long-lasting, low maintenance installations are desired.

It is a purpose of the invention to provide an improved mounting bracket.

It is a further purpose of the invention to provide an improved mounting bracket for use in outdoor applications.

It is another purpose of the invention to provide a durable, cost-effective mounting bracket for use in outdoor applications.

It is yet another purpose of the invention to provide an improved mounting bracket for use in solar panel installations.

### SUMMARY OF THE INVENTION

The invention is a mounting bracket for attaching two support structures together, such as a support beam or channel to a vertical support post which would be attached at a pre-determined angle. The mounting bracket has a cavity for receiving the vertical support post, the cavity being attached to a side of a support plate at the pre-determined angle. The support plate is attached to the channel, such that the channel is supported from the ground at the desired angle. The invention is designed to be used with installations requiring a consistent angular relationship between the vertical support post and the channel, such as solar panel arrays.

### BRIEF DESCRIPTION OF THE DRAWINGS

FIG. 1 is perspective view of the invention.

FIG. 2 is a front end view of the invention.

FIG. 3 is side view of the invention, showing a cross section of the cap.

FIG. 4 is side view of the invention, being supported by a mounting post and supporting a solar panel array.

FIG. 5 is a front view of the invention, being supported by a mounting post and supporting channels and framing for a solar panel array, without the solar panels in place.

FIG. 6 is a perspective view of the invention, being supported by a mounting post and supporting a solar panel array.

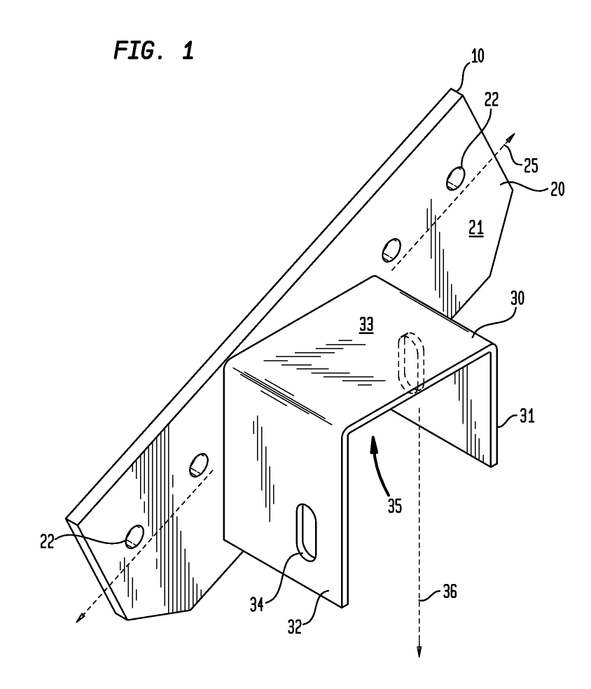

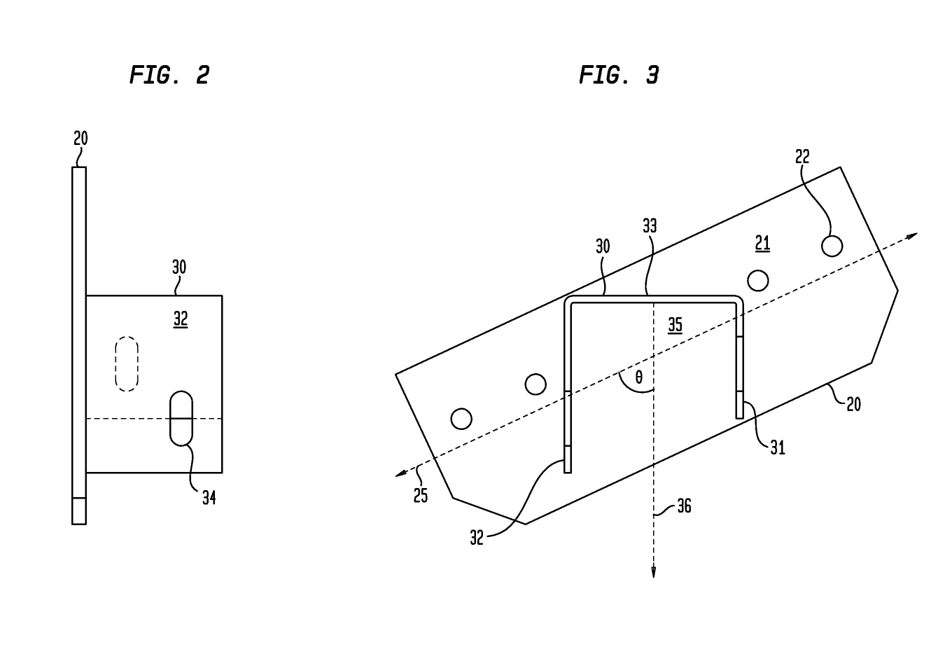

### DETAILED DESCRIPTION OF THE PREFERRED EMBODIMENT

The invention is a mounting bracket 10 with a support plate 20 and a cap 30 attached to a side of the support plate 20.

Cap 30 has two sides 31, 32 which are approximately parallel to each other, and an end plate 33. The two sides 31, 32 do not need to be the same length and preferably are of unequal lengths. The end plate 33 is preferably a wide flat surface. Cap 30 may be U-shaped, with the sides 31, 32 and end plate 33 being approximately equal in width, forming a cavity 35. Slots 34 are provided in sides 31, 31 to allow cap 30 to be attached to an additional support structure, as discussed below. Cap 30 is preferably constructed of a rectangular metal plate, bent in two places to form the U-shape. Cavity 35 has an orientation axis 36, where orientation axis 36 points in a particular direction, preferably perpendicular to end plate 33.

Support plate 20 can be of any dimension and has a longitudinal axis 25 in the direction of the length of the support plate. Support plate 20 is also preferably constructed of metal. Support plate 20 has apertures 22 for use in securing support plate 20 to channel 40, or another support structure.

Cap 30 is attached to a side of support plate 20, with orientation axis 36 of cavity 35 at an oblique angle θ with respect to the longitudinal axis 25 of support plate 20. Cap 30 is preferably welded to support plate 20, or otherwise permanently affixed to support plate 20, such that oblique angle θ is fixed. Cavity 35 is preferably oriented roughly parallel to the surface plane 21 of support plate 20.

The orientation of cap 30 with respect to support plate 20, namely the angle θ, is preferably pre-determined based upon the expected use of the invention. The invention is intended for use with installations that require a consistent angle across multiple mounting brackets 10 used for the same installation. Therefore, each cap 30 is preferably welded to each support plate 20 in a manner that angle θ will be the same for each mounting bracket 10. For solar panel installations in a given location, angle θ will be calculated to maximize the efficiency of the solar panels at such location.

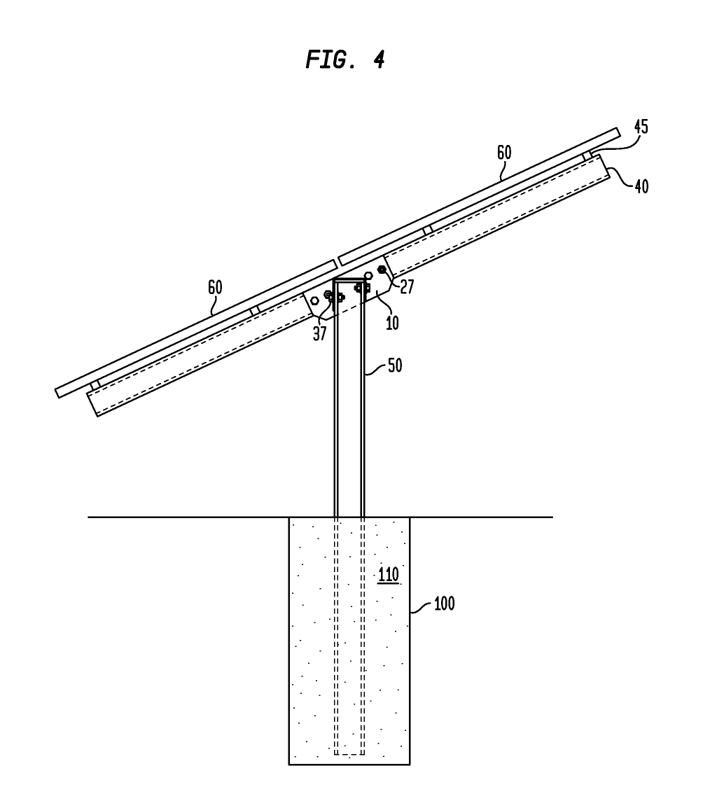

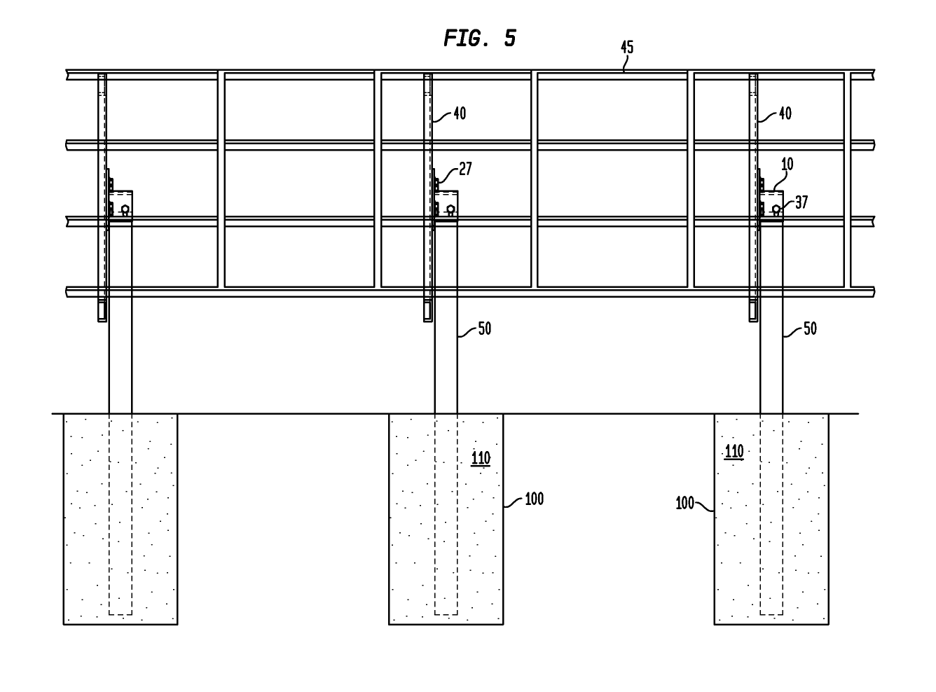

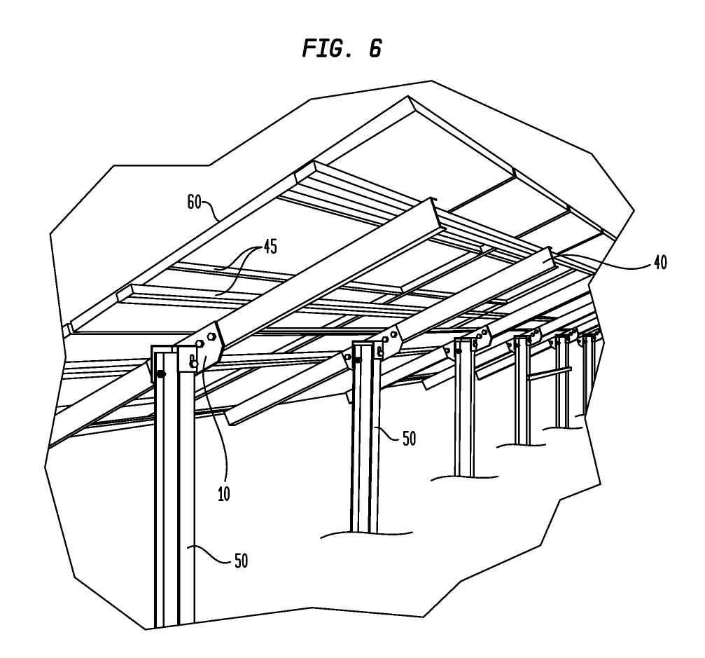

Mounting bracket 10 of the present invention is intended for use with ground mounted solar panel installations, as shown in FIGS. 4-6. In solar panel installations, the array of solar panels is preferably oriented at a particular angle, based upon the latitude of the installation. As is known in the art, each panel of the array is desired to be at the same angle, regardless of the terrain of the installation location.

In the preferred ground-mount solar panel installation, a support post 50 is inserted into the ground. The support post 50 is preferably a metal beam, driven into the ground, or placed into hole 100 in the ground and affixed with footing 100, such as concrete as is known in the art. Support post 50 preferably has a flat upper end, which allows for the support post to be driven into the ground by force in appropriate conditions, without requiring a previously-prepared hole or footing.

Mounting bracket 10 of the present invention is placed on the top of the support post 50, inserting the top end of the support post into the cavity 35. Where support post 50 has a flat upper end, having a flat end plate 17 allows the cap to rest on top of the support post. Preferably, the cap 30 is affixed to the support post 50 by post attachment means 37. Post attachment means 37 may be bolts or other secure attachment means as are known in the art. Slots 34 are provided in the sides 31, 32 of cap 30 to allow the cap to be raised or lowered as needed for a desired height.

Support plate 20 of mounting bracket 10 is attached to a channel 40 that supports framing 45 which in turn supports one or more solar panels 60. Preferably, channel 40 is attached to support plate 20 with the longitudinal axis 25 of the support plate parallel to the length of channel 40. Attachment means 27 are used to attach channel 40 to support plate 20, and may be bolts or other secure attachment means as are known in the art. Support plate 20 may have holes 24 through which bolts may be passed to secure the channel 40 to support plate 20.

After mounting bracket 10 is attached to support post 50 and channel 40, channel 40 will be oriented at the desired angle θ with respect to support post 50. A plurality of assemblies of support post, mounting bracket and channel in a row will support one array of solar panels. Several arrays are commonly used in ground-mount solar panel installations, as is known in the art.

While certain novel features of the present invention have been shown and described, it will be understood that various omissions, substitutions and changes in the forms and details of the device illustrated and in its operation can be made by those skilled in the art without departing from the spirit of the invention.

I claim:

1. A mounting bracket comprising:
a support plate with front and rear sides, the support plate having an axis extending in a first direction;
an end cap formed by a flat end plate and two sides, the two sides being approximately perpendicular to the end plate and parallel to each other, leaving an opening between the two sides, the opening oriented in a direction distal from the end plate;
where the end cap is attached to the front side of the support plate, directing the opening at an oblique angle with respect to the axis of the support plate.

2. The mounting bracket of claim 1, where the oblique angle is between 0 and 90 degrees.

3. The mounting bracket of claim 1, further comprising:
at least one opening in at least one side of the end cap, allowing the end cap to be adjustably secured to a support post.

4. The mounting bracket of claim 1:
where the front side of the support plate forms a plane; and
where the opening of the end cap is oriented parallel to the plane of the support plate.

5. The mounting bracket of claim 1, further comprising:
at least one opening in the support plate, allowing the support plate to be adjustably secured to a support channel.

6. A mounting bracket comprising:
an elongated plate, the elongated plate having an axis along its length and comprising a plane;
an end cap formed by a flat end plate and two sides, the two sides being approximately perpendicular to the end plate and parallel to each other, leaving a cavity between the two sides, the cavity oriented in a direction distal from the end plate;
the end cap fixedly attached to the elongated plate, where the cavity is oriented at an oblique angle with respect to the axis of the elongated plate and parallel to the plane of the elongated plate.

7. The mounting bracket of claim 6, further comprising:
at least one opening in at least one side of the end cap, allowing the end cap to be adjustably secured to a support post.

8. The mounting bracket of claim 6, further comprising:
at least one opening in the support plate, allowing the support plate to be adjustably secured to a support channel.

9. A solar panel support structure comprising:
an elongated post with a base end and an upper end, the elongated post having a first axis;
a mounting bracket comprised of two sides and an end, forming a cavity within the two sides and end, where the cavity is capable of receiving the upper end of the elongated post when aligned with the first axis;
a support plate with front and rear sides, the support plate having a second axis, where the mounting bracket is attached to the front side of the support plate with the cavity diverging from the second axis; and
an elongated solar panel support having a third axis, the elongated solar panel support attached to the rear side of the support plate.

10. The solar panel support structure of claim 9, where the second axis is parallel to the third axis.

11. The solar panel support structure of claim 9, where the first axis and the second axis meet at an oblique angle.

12. The solar panel support structure of claim 9, further comprising:
at least one opening in at least one side of the mounting bracket, allowing the mounting bracket to be adjustably secured to the elongated post.

13. The solar panel support structure of claim 9, further comprising:
at least one opening in the support plate, allowing the support plate to be adjustably secured to the elongated solar panel support.

14. The solar panel support structure of claim 9, where the elongated post and the elongated solar panel support meet at an oblique angle.
